(19) United States
(12) Patent Application Publication
(10) Pub. No.: US 2026/0311638 A1
(43) Pub. Date: Oct. 8, 2026

(54) APPARATUS FOR CONTROL DISPLAY PANEL AND METHOD FOR OPERATING DISPLAY DEVICE INCLUDING THE SAME

(71) Applicant: LX SEMICON CO., LTD., Daejeon (KR)

(72) Inventor: Seok Hoo KIM, Daejeon (KR)

(73) Assignee: LX SEMICON CO., LTD., Daejeon (KR)

(21) Appl. No.: 19/632,859

(22) Filed: Mar. 30, 2026

(30) Foreign Application Priority Data
Apr. 7, 2025 (KR) 10-2025-0044688

(51) Int. Cl. G09G 3/3225

(52) U.S. Cl. CPC G09G 3/3225; G09G 2310/08; G09G 2320/0233; G09G 2320/0285; G09G 2320/041

(57) ABSTRACT

A display panel control apparatus capable of calculating temperatures for respective regions of a display panel without using a plurality of temperature sensors comprises: a first temperature sensor configured to obtain a temperature of a display panel divided into a plurality of regions, and a timing controller configured to calculate current temperatures for the respective regions by using pre-obtained temperature deviation information for respective regions of the display panel and a first reference temperature obtained by the first temperature sensor in a driving stage of the display panel for luminance of the display panel by using the calculated current temperatures for the respective regions.

### CROSS-REFERENCE TO RELATED APPLICATION

This application claims the priority of Korean Patent Application No. 10-2025-0044688 filed on Apr. 07, 2025 which is hereby incorporated by reference in its entirety.

### BACKGROUND

### Field of the Disclosure

The present disclosure relates to a display device, and more particularly, to a display panel control apparatus.

### Description of the Background

Organic light emitting diode (hereinafter referred to as “OLED”) display devices include self-emissive OLEDs, and have advantages such as fast response speed, high luminous efficiency, high luminance, and a wide viewing angle.

An OLED, which is a self-emissive element, includes an anode electrode, a cathode electrode, and an organic compound layer formed therebetween, where the organic compound layer includes a hole injection layer (HIL), a hole transport layer (HTL), an emission layer (EML), an electron transport layer (ETL), and an electron injection layer (EIL). When a supply voltage is applied to the anode and cathode electrodes, holes having passed through the HTL and electrons having passed through the ETL move to the EML to form excitons, whereby the EML emits visible light.

OLED display devices arrange sub-pixels, each including an OLED and a driving thin film transistor (TFT), in a matrix, and controls the luminance of an input image implemented through the sub-pixels according to the gradation of image data. The driving transistor controls a pixel current flowing through the OLED according to a voltage applied between its gate electrode and source electrode. The amount of light emitted from the OLED is determined by the pixel current and the luminance of the image data is determined according to the amount of light emitted from the OLED.

The pixel current flowing through the OLED may vary depending on a temperature of a display panel, and thus may change a luminance of the OLED. Accordingly, in order to compensate for luminance non-uniformity caused by temperature variation, techniques have been proposed in which a temperature of the display panel is detected by using a temperature sensor, and image data are corrected such that a uniform luminance is output according to the detected temperature.

However, as shown in FIG. 1, in a general display device 10, due to spatial constraints, only one temperature sensor 13 is mounted on a control printed circuit board (CPCB) on which a timing controller 12 is mounted. Here, the control printed circuit board is disposed outside a display panel 11. Therefore, since the luminance of all pixels of the display panel 11 is compensated based on temperature data obtained by the single temperature sensor 13, it is difficult to properly compensate for luminance deviations caused by temperature variations in respective regions of the display panel 11, and thus display defects such as display mura may occur.

To address the above problem, it may be considered to dispose a plurality of temperature sensors to accurately obtain temperatures of respective regions of the display panel. However, disposing the plurality of temperature sensors on the display panel is technically and economically impractical due to cost and structural constraints.

### SUMMARY

The present disclosure is to provide a display panel control apparatus and a method for operating a display device including the same capable of calculating temperatures of respective regions of the display panel without using a plurality of temperature sensors.

The present disclosure is to provide a display panel control apparatus and a method for operating a display device including the same capable of calculating current temperatures for respective regions of the display panel by using temperature deviation information for the respective regions of the display panel obtained during manufacturing of the display panel, and compensating for a luminance of the display panel based on the calculated current temperatures of the respective regions.

According to an aspect of the present disclosure, there is provided a display panel control apparatus comprising: a first temperature sensor configured to obtain a temperature of a display panel divided into a plurality of regions; and a timing controller configured to calculate current temperatures for the respective regions by using pre-obtained temperature deviation information for respective regions of the display panel and a first reference temperature obtained by the first temperature sensor in a driving stage of the display panel and compensate for luminance of the display panel by using the calculated current temperatures for the respective regions.

According to an aspect of the present disclosure, there is provided a method for operating a display device including a display panel divided into a plurality of regions, the method comprising: obtaining a first reference temperature of the display panel by using a first temperature sensor in a driving stage of the display panel, calculating current temperatures for the respective regions of the display panel by using the first reference temperature and pre-obtained temperature deviation information for the respective regions of the display panel, and compensating for a luminance of the display panel by using the calculated current temperatures for the respective regions.

### BRIEF DESCRIPTION OF THE DRAWINGS

The accompanying drawings, which are included to provide a further understanding of the disclosure and are incorporated in and constitute a part of this application, illustrate aspects of the disclosure and together with the description serve to explain the principle of the disclosure.

### IN THE DRAWINGS

FIG. 1 schematically illustrates a configuration of a conventional display device;

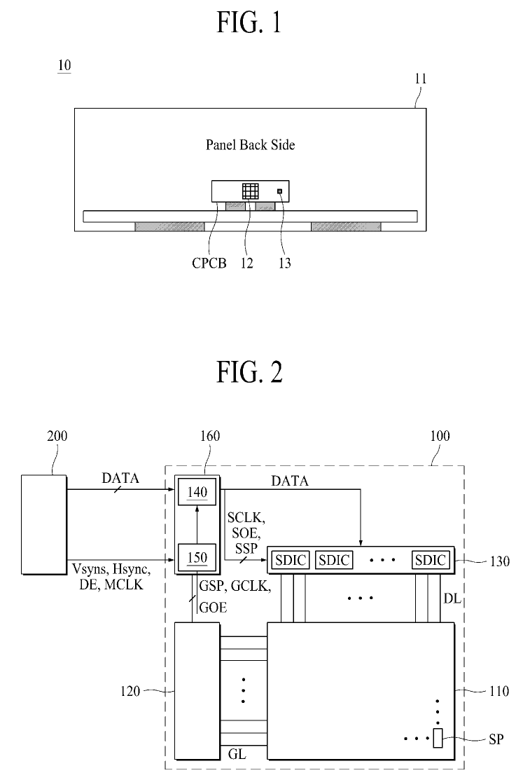

FIG. 2 illustrates a configuration of a display device according to an aspect of the present disclosure;

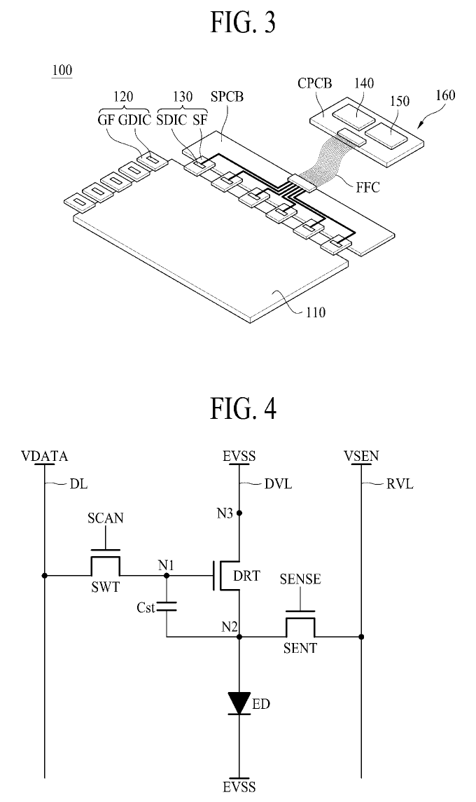

FIG. 3 illustrates an exemplary display device according to an aspect of the present disclosure;

FIG. 4 is a circuit diagram illustrating a configuration of a subpixel according to an aspect of the present disclosure;

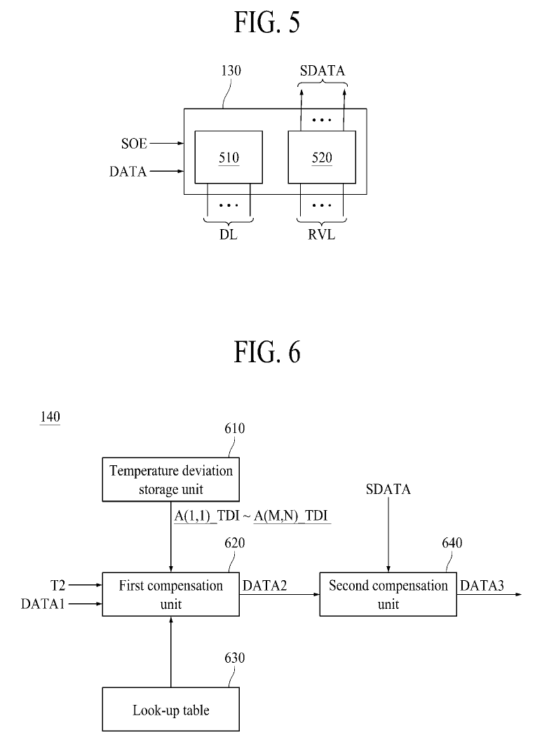

FIG. 5 schematically illustrates a configuration of a data driving circuit illustrated in FIG. 2;

FIG. 6 is a block diagram schematically illustrating a configuration of a timing controller according to an aspect of the present disclosure;

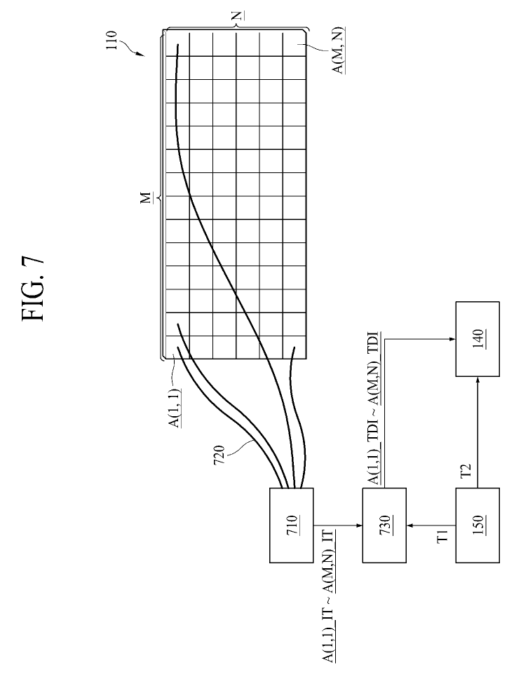

FIG. 7 is a diagram for explaining a method of measuring initial temperatures of respective regions of a display panel by using a radiation thermometer according to an aspect of the present disclosure; and

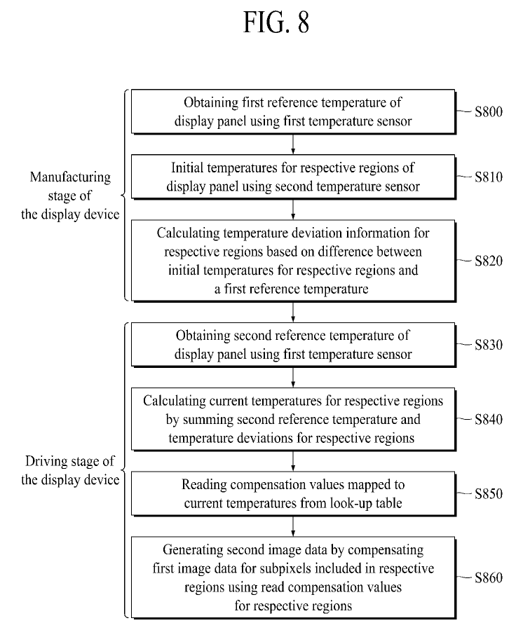

FIG. 8 is a flowchart illustrating a driving method for the display device according to an aspect of the present disclosure.

### DETAILED DESCRIPTION

Like reference numerals refer to like elements throughout. In the following description, when the detailed description of the relevant known function or configuration is determined to unnecessarily obscure the important point of the present disclosure, the detailed description will be omitted.

Advantages and features of the present disclosure, and implementation methods thereof will be clarified through following exemplary aspects described with reference to the accompanying drawings. The present disclosure may, however, be embodied in different forms and should not be construed as limited to the exemplary aspects set forth herein. Rather, these exemplary aspects are provided so that this disclosure will be thorough and complete, and will fully convey the scope of the present disclosure to those skilled in the art. Further, the present disclosure is only defined by scopes of claims.

A shape, a size, a ratio, an angle, and a number disclosed in the drawings for describing exemplary aspects of the present disclosure are merely an example, and thus, the present disclosure is not limited to the illustrated details.

In a case where “include,” “have,” “comprise,” “contain,” “constitute,” “make up of,” “formed of,” and “consist of” described in the present specification are used, another part can be added unless ‘only~’ is used. The terms of a singular form can include plural forms unless referred to the contrary.

In construing an element, the element is construed as including an error range although there is no explicit description.

In describing a position relationship, for example, when a position relation between two parts is described as “on”, “above”, “over”, “below”, “under”, “beside”, “beneath”, “near”, “close to, ” “adjacent to”, “on a side of”, “next”, one or more other parts may be disposed between the two parts unless ‘just’ or ‘direct’ is used.

It will be understood that, although the terms “first”, “second” etc. can be used herein to describe various elements, these elements should not be limited by these terms. These terms are only used to distinguish one element from another. Accordingly, a first element mentioned hereinafter could be termed a second element without departing from the scope of the present disclosure.

The term “at least one” should be understood as including any and all combinations of one or more of the associated listed items. For example, the meaning of “at least one of a first item, a second item, and a third item” denotes each of the first item, the second item, and the third item as well as the combination of all items proposed from two or more of the first item, the second item, and the third item.

Features of various exemplary aspects of the present disclosure can be partially or overall coupled to or combined with each other and can be variously inter-operated or combined with each other and driven technically as those skilled in the art can sufficiently understand. The exemplary aspects of the present disclosure can be carried out independently from each other, or can be carried out together in co-dependent relationship.

Hereinafter, example aspects of the present disclosure will be described in detail with reference to the accompanying drawings.

FIG. 2 illustrates a configuration of a display device according to an aspect of the present disclosure and FIG. 3 illustrates an exemplary display device according to an aspect of the present disclosure.

The display device 100 illustrated in FIGS. 2 and 3 may an electronic device including a display panel control apparatus according to the present disclosure, and may be various types of display devices that use a voltage of a battery or an external power supply as an operating voltage. In one aspect, the display device 100 may be an in-vehicle display device mounted in an automobile.

Referring to FIG. 2, the display device 100 according to the present disclosure includes a display panel 110 in which a plurality of gate lines GL and a plurality of data lines DL are connected and a plurality of subpixels SP are arranged in a matrix form, a gate driving circuit 120 configured to drive the plurality of gate lines GL, a data driving circuit 130 configured to supply data voltages through the plurality of data lines DL, and a display panel control apparatus 160 configured to control the gate driving circuit 120 and the data driving circuit 130. In addition, as illustrated in FIGS. 2 and 3, the display panel control apparatus 160 may include a timing controller 140 and a first temperature sensor 150.

The display panel 110 displays an image based on scan signals transmitted from the gate driving circuit 120 through the plurality of gate lines GL and data voltages transmitted from the data driving circuit 130 through the plurality of data lines DL.

In one aspect, the display panel 110 may be an organic light emitting diode hereinafter referred to as “OLED”) display panel or a micro light emitting diode (micro-LED) display panel. When the display panel 110 is the OLED display panel, the display panel 110 may be implemented as, for example, a top emission type, a bottom emission type, a dual emission type, and the like.

Hereinafter, for convenience of description, it is assumed that the display panel 110 is the OLED display panel.

The display panel 110 may include a plurality of pixels arranged in a matrix form. Each pixel includes subpixels SP of different colors, for example, a white subpixel, a red subpixel, a green subpixel, and a blue subpixel, and each subpixel SP may be defined by the plurality of data lines DL and the plurality of gate lines GL.

The subpixel SP may include a thin film transistor (TFT) formed in a region where one data line DL and one gate line GL intersect, an OLED, and a storage capacitor electrically connected to the OLED to maintain a voltage. An image may be displayed by controlling a current flowing through the OLED disposed in each subpixel SP.

Hereinafter, with reference to FIG. 4, a configuration of a subpixel according to an aspect of the present disclosure will be described. FIG. 4 is a circuit diagram illustrating a configuration of a subpixel according to an aspect of the present disclosure.

Referring to FIG. 4, the subpixel SP may include a driving transistor DRT, a switching transistor SWT, a sensing transistor SENT, a storage capacitor Cst, and an organic light emitting diode ED.

The driving transistor DRT includes a first node N1, a second node N2, and a third node N3. The first node N1 of the driving transistor DRT may be a gate node to which a data voltage VDATA is applied through the data line DL when the switching transistor SWT is turned on. The second node N2 of the driving transistor DRT may be electrically connected to an anode electrode of the organic light emitting diode ED and may be a source node or a drain node. The third node N3 of the driving transistor DRT is electrically connected to a driving voltage line DVL to which a driving voltage EVDD is applied and may be the drain node or the source node.

In this case, during a display driving period, the driving voltage EVDD required to display an image may be supplied through the driving voltage line DVL.

The switching transistor SWT is electrically connected between the first node N1 of the driving transistor DRT and the data line DL and has a gate node connected to the gate line GL so as to operate in response to a scan signal SCAN supplied through the gate line GL. In addition, when the switching transistor SWT is turned on, the data voltage VDATA supplied through the data line DL is transferred to the gate node of the driving transistor DRT, thereby controlling the operation of the driving transistor DRT.

The sensing transistor SENT is electrically connected between the second node N2 of the driving transistor DRT and a reference line RVL and has a gate node connected to the gate line GL so as to operate in response to a sense signal SENSE supplied through the gate line GL. When the sensing transistor SENT is turned on, a sensing reference voltage VSEN supplied through the reference line RVL is transferred to the second node N2 of the driving transistor DRT.

That is, by controlling the switching transistor SWT and the sensing transistor SENT, voltages at the first node N1 and the second node N2 of the driving transistor DRT are controlled, and thus a current for driving the organic light emitting diode ED can be supplied.

The gate nodes of the switching transistor SWT and the sensing transistor SENT may be connected to one gate line GL in common, or may be connected to different gate lines GL. In FIG. 4, a structure in which the switching transistor SWT and the sensing transistor SENT are connected to different gate lines GL is illustrated as an example, and in this case, the switching transistor SWT and the sensing transistor SENT may be independently controlled by the scan signal SCAN and the sense signal SENSE transmitted through the different gate lines GL, respectively.

In contrast, when the switching transistor SWT and the sensing transistor SENT are connected to one gate line GL in common, the switching transistor SWT and the sensing transistor SENT may be simultaneously controlled by the scan signal SCAN or the sense signal SENSE transmitted through the one gate line GL, and an aperture ratio of the subpixel SP may be increased.

Meanwhile, the transistors disposed in the subpixel SP may be implemented as n-type transistors or p-type transistors, and in FIG. 4, an example in which the transistors are implemented as n-type transistors is illustrated.

The storage capacitor Cst is electrically connected between the first node N1 and the second node N2 of the driving transistor DRT and maintains the data voltage VDATA for one frame.

The storage capacitor Cst may be connected between the first node N1 and the third node N3 of the driving transistor DRT according to the type of the driving transistor DRT. An anode electrode of the organic light emitting diode ED may be electrically connected to the second node N2 of the driving transistor DRT, and a base voltage EVSS may be applied to a cathode electrode of the organic light emitting diode ED.

Here, the base voltage EVSS may be a ground voltage, or a voltage higher or lower than the ground voltage. In addition, the base voltage EVSS may be variable according to a driving state. For example, the base voltage EVSS during a display period and the base voltage EVSS during a sensing period may be set to be different from each other.

Since the reference line RVL transfers the sensing reference voltage VSEN and also serves as a sensing line for sensing a characteristic value of the driving transistor DRT in the subpixel SP, the reference line RVL may be referred to as a sensing line.

The above-described structure of the subpixel SP is a 3T (transistor)-1C (capacitor) structure, and is merely an example for explanation, and the subpixel SP may further include one or more additional transistors and, in some cases, may further include one or more additional capacitors. Each of the plurality of subpixels SP may be formed to have the same structure, or some of the plurality of subpixels SP may be formed to have different structures.

Referring again to FIGS. 2 and 3, the gate driving circuit 120 is controlled by the timing controller 140. The gate driving circuit 120 controls driving timings of the plurality of subpixels SP by sequentially outputting scan signals to the plurality of gate lines GL disposed in the display panel 110.

As illustrated in FIG. 3, the gate driving circuit 120 may include at least one gate driver integrated circuit (GDIC), and, depending on a driving scheme, may be disposed only at one side of the display panel 110 or at both sides of the display panel 110. In another aspect, the gate driving circuit 120 may be implemented as a gate in panel (GIP) type, in which the gate driving circuit 120 is embedded in a bezel region of the display panel 110.

Each of one or more gate driver integrated circuits GDIC included in the gate driving circuit 120 may be mounted on a gate film GF, and one side of the gate film GF may be electrically connected to the display panel 110. In addition, on an upper portion of the gate film GF, wirings for electrically connecting the gate driver integrated circuit GDIC and the display panel 110 may be disposed.

The data driving circuit 130 receives image data DATA from the timing controller 140 and converts the received image data DATA into analog data voltages. The data driving circuit 130 outputs the data voltages to the respective data lines DL in synchronization with timings at which scan signals are applied through the gate lines GL, so that each subpixel SP connected to the data lines DL displays an emission signal having a luminance corresponding to the data voltage.

As illustrated in FIG. 3, the data driving circuit 130 may include at least one source driver integrated circuit (SDIC). The source driver integrated circuit SDIC may be connected to bonding pads of the display panel 110 in a tape automated bonding (TAB) scheme or a chip-on-glass (COG) scheme, or may be directly disposed on the display panel 110.

In one aspect, each source driver integrated circuit SDIC may be integrated and disposed on the display panel 110. In addition, each source driver integrated circuit SDIC may be implemented in a chip-on-film (COF) scheme, and in this case, each source driver integrated circuit SDIC may be mounted on a circuit film and may be electrically connected to the data lines DL of the display panel 110 through the circuit film.

One or more source driver integrated circuits SDIC included in the data driving circuit 130 may be mounted on a source film SF, respectively, and one side of the source film SF may be electrically connected to the display panel 110. In addition, on an upper portion of the source film SF, wirings for electrically connecting the source driver integrated circuit SDIC and the display panel 110 may be disposed.

At this time, at least one source printed circuit board SPCB may be connected to the other side of the source film SF on which the source driver integrated circuit SDIC is mounted. That is, the source film SF on which the source driver integrated circuit SDIC is mounted may have one side electrically connected to the display panel 110 and the other side electrically connected to the source printed circuit board SPCB.

In one aspect, the data driving circuit 130 may sense characteristics of the subpixels SP included in the display panel 110 to generate sensing data and transmit the generated sensing data to the timing controller 140, so that the timing controller 140 compensates image data to be output through the respective subpixels based on the sensing data of the respective subpixels.

To this end, as illustrated in FIG. 5, the data driving circuit 130 may include a data voltage output circuit 510 and a sensing circuit 520.

The data voltage output circuit 510 receives the image data DATA from the timing controller 140, converts the received image data DATA into analog data voltages, and outputs the analog data voltages to the respective data lines DL. In this case, the image data received from the timing controller 140 may be first image data whose luminance is compensated according to a temperature obtained by the first temperature sensor 150, or second image data obtained by compensating the first image data based on sensing data SDATA.

During the sensing period for sensing characteristic values such as a threshold voltage or a mobility of the driving transistor DRT disposed in the subpixel SP, the sensing circuit 520 is connected to each subpixel SP through the reference line RVL, supplies the sensing reference voltage VSEN to the subpixel SP through the reference line RVL, and converts a signal transmitted from the reference line RVL into a digital value to generate sensing data SDATA. The sensing circuit 520 transmits the sensing data SDATA to the timing controller 140.

In one aspect, the sensing circuit 520 may use a current sensing scheme of measuring a current flowing due to a voltage charged in the storage capacitor Cst during the sensing period. That is, the sensing circuit 520 may detect a characteristic value or a variation in the characteristic value of the driving transistor DRT in the subpixel SP by measuring a current flowing due to a voltage charged in the storage capacitor Cst during the sensing period.

In this case, the sensing circuit 520 converts a current value obtained through the reference line RVL into a digital value to generate the sensing data SDATA, and transmits the generated sensing data SDATA to the timing controller 140.

Referring again to FIGS. 2 and 3, the timing controller 140 supplies control signals to the gate driving circuit 120 and the data driving circuit 130 to control operations of the gate driving circuit 120 and the data driving circuit 130. That is, the timing controller 140 controls the gate driving circuit 120 to output scan signals according to timings implemented in the each frame, and transmits image data DATA received from the outside to the data driving circuit 130 to control the data driving circuit 130 to output data voltages corresponding to the image data DATA to the data lines DL.

At this time, the timing controller 140 may receive a timing signal including a vertical synchronization signal Vsync, a horizontal synchronization signal Hsync, a data enable signal DE, a main clock MCLK, and the like together with the image data DATA from an external host system 200.

The host system 200 may be any one of a television (TV) system, a set-top box, a navigation system, a personal computer (PC), a home theater system, a mobile device, and a wearable device.

Accordingly, the timing controller 140 generates control signals by using the timing signals received from the host system 200 and transfers the control signals to the gate driving circuit 120 and the data driving circuit 130.

For example, in order to control the gate driving circuit 120, the timing controller 140 outputs gate control signals including a gate start pulse GSP, a gate clock GCLK, a gate output enable signal GOE, and the like to the gate driving circuit 120.

Here, the gate start pulse GSP controls a timing at which at least one gate driver integrated circuit GDIC constituting the gate driving circuit 120 starts an operation. The gate clock GCLK is a clock signal commonly input to the at least one gate driver integrated circuit GDIC and controls shift timings of scan signals. The gate output enable signal GOE specifies timing information of at least one gate driver integrated circuit GDIC.

Additionally, in order to control the data driving circuit 130, the timing controller 140 outputs data control signals including a source start pulse SSP, a source sampling clock SCLK, a source output enable signal SOE, and the like to the data driving circuit 130. Here, the source start pulse SSP controls a timing at which at least one source driver integrated circuit SDIC constituting the data driving circuit 130 starts data sampling. The source sampling clock SCLK is a clock signal for controlling timings at which the at least one source driver integrated circuit SDIC samples data, and the source output enable signal SOE controls output timings of the at least one source driver integrated circuit SDIC.

In addition, the timing controller 140 according to the present disclosure may compare the sensing data SDATA received from the sensing circuit 520 with a pre-stored reference value to generate compensation data for compensating for a deviation in the characteristic value of the driving transistor disposed in the subpixel SP connected to the sensing circuit 520, and may compensate image data by reflecting the generated compensation data in the image data.

In particular, the timing controller 140 according to the present disclosure may compensate for a luminance of the display panel 110 by compensating image data to be output to each subpixel SP according to a temperature of the display panel 110. To this end, as illustrated in FIGS. 2 and 3, the display panel control apparatus 160 according to the present disclosure may include the first temperature sensor 150 for measuring a temperature of the display panel 110.

In one aspect, as illustrated in FIG. 3, the first temperature sensor 150 may be mounted on a control printed circuit board CPCB together with the timing controller 140. In this case, the control printed circuit board CPCB and the at least one source printed circuit board SPCB may be electrically connected through at least one connection member, and the connection member may be, for example, a flexible printed circuit (FPC), a flexible flat cable (FFC), or the like. The connection member connecting the at least one source printed circuit board SPCB and the control printed circuit board CPCB may be variously changed according to a size and a type of the display device 100. In addition, the at least one source printed circuit board SPCB and the control printed circuit board CPCB may be integrated into one printed circuit board.

The first temperature sensor 150 obtains a first reference temperature T1, which is a temperature of the display panel 110, in a manufacturing stage of the display device 100, and obtains a second reference temperature T2, which is a temperature of the display panel 110, in a driving stage of the display device 100. Here, the driving stage of the display device 100 refers to a concept distinguished from a form in which the display device 100 is driven in the manufacturing stage of the display device 100, and, for example, may mean that a user drives and uses the display device 100 after manufacturing of the display device 100. At this time, since the first temperature sensor 150 is mounted on the control printed circuit board CPCB together with the timing controller 140 as illustrated in FIG. 3, the first reference temperature T1 and the second reference temperature T2 measured by the first temperature sensor 150 may be defined as temperatures of an area where the first temperature sensor 150 is mounted on the display panel 110.

The first reference temperature T1 is used to calculate temperature deviation information for the respective regions of the display panel 110 in the manufacturing stage of the display panel 110, and the second reference temperature T2 is used to calculate current temperatures for the respective regions of the display panel 110 in the driving stage of the display panel 110.

The timing controller 140 calculates current temperatures for the respective regions of the display panel 110 by using the temperature deviation information for the respective regions calculated based on the first reference temperature T1 and the second reference temperature T2, and compensates for luminance of the display panel 110 for the respective regions by using the current temperatures for the respective regions.

Hereinafter, the timing controller 140 according to an aspect of the present disclosure will be described in more detail with reference to FIG. 6.

FIG. 6 is a block diagram schematically illustrating a configuration of a timing controller according to an aspect of the present disclosure. As illustrated in FIG. 6, the timing controller 140 according to the aspect of the present disclosure includes a temperature deviation storage unit 610, a first compensation unit 620, a look-up table 630, and a second compensation unit 640.

The temperature deviation storage unit 610 stores temperature deviations for the respective regions between the first reference temperature T1, which is a temperature of the display panel 110 obtained by the first temperature sensor 150 in the manufacturing stage of the display device 100, and initial temperatures for the respective regions of the display panel 110 obtained by using a second temperature sensor different from the first temperature sensor 150 in the manufacturing stage of the display panel 110.

In one aspect, the first reference temperature T1 and the initial temperatures for the respective regions may be obtained by the first temperature sensor 150 and the second temperature sensor while a predetermined test image is output through the display panel 110.

In another aspect, the first reference temperature T1 and the initial temperatures for the respective regions may be obtained by the first temperature sensor 150 and the second temperature sensor while predetermined data voltages are supplied to the respective subpixels SP through the data lines DL of the display panel 110.

That is, in the manufacturing stage of the display device 100 according to the present disclosure, the first reference temperature T1 of the display panel 110 is obtained by using the first temperature sensor 150, the initial temperatures for the respective regions of the display panel 110 are obtained by using the second temperature sensor, the temperature deviation information, which is a difference between the first reference temperature T1 and the initial temperatures for the respective regions, is calculated and stored in the temperature deviation storage unit 610. At this time, the temperature deviation information may be calculated by using a separate external device (not illustrated) or may be calculated by the first compensation unit 620.

The reason for calculating the temperature deviation information, which is a difference between the first reference temperature T1 and the initial temperatures for the respective regions, and storing the temperature deviation information in the temperature deviation storage unit 610 in the present disclosure is to calculate current temperatures for the respective regions of the display panel 110 by using the second reference temperature T2 obtained by the first temperature sensor 150 and the temperature deviation information for the respective regions in the driving stage of the display device 100.

In a general display device, since a temperature obtained by one temperature sensor mounted on the display panel 110 is uniformly applied to all regions of the display panel 110 to compensate for a luminance of the display panel 110, compensation accuracy is inevitably low. Therefore, in the present disclosure, by storing the temperature deviation information corresponding to relative temperature information for the respective regions with respect to the first reference temperature T1 obtained by the first temperature sensor 150, even if only the second reference temperature T2 of the display panel 110 is obtained by the first temperature sensor 150 in the actual driving stage of the display device 100, current temperatures for all regions of the display panel 110 can be calculated without adding a separate temperature sensor.

In one aspect, the second temperature sensor for obtaining initial temperatures for the respective regions of the display panel 110 in the manufacturing stage of the display device 100 may be a radiation thermometer. Hereinafter, with reference to FIG. 7, a method of measuring initial temperatures for the respective regions of the display panel 110 by using the radiation thermometer will be briefly described.

As illustrated in FIG. 7, the display panel 110 may be divided into M×N regions A(1,1) to A(M,N).

In the manufacturing stage of the display device 100, the radiation thermometer 710 is connected to each region A(1,1) to A(M,N) of the display panel 110 through a plurality of wires 720. That is, the radiation thermometer 710 is not included in the display device 100, but is connected only in the manufacturing stage of the display device 100 to obtain surface temperatures for the respective regions A(1,1) to A(M,N) of the display panel 110 to which each wire 720 is connected. The radiation thermometer 710 transmits surface temperatures for the respective regions obtained to an external device 730 as initial temperatures A(1,1)_IT to A(M,N)_IT for the respective regions.

As described above, while a predetermined test image is output through the display panel 110 or predetermined data voltages are supplied to the respective subpixels SP through the data lines DL of the display panel 110, surface temperatures for the respective regions A(1,1) to A(M,N) of the display panel 110 may be obtained by using the radiation thermometer 710.

The wires 720 may be connected to surfaces of the respective regions A(1,1) to A(M,N) of the display panel 110. In one aspect, the wires 720 may be thermocouple wires.

The external device 730 calculates the temperature deviation information A(1,1)_TDI to A(M,N)_TDI for the respective regions of the display panel 110 by using initial temperatures A(1,1)_IT to A(M,N)_IT for the respective regions transmitted from the radiation thermometer 710 and the first reference temperature T1 of the display panel 110 transmitted from the first temperature sensor 150. The external device 730 stores the calculated the temperature deviation information A(1,1)_TDI to A(M,N)_TDI for the respective regions in the temperature deviation storage unit 610 of the timing controller 140.

In the above-described aspect, the display panel 110 is divided into M×N regions A(1,1) to A(M,N), and initial temperatures for the M×N regions A(1,1) to A(M,N) are obtained by using the radiation thermometer 710.

However, in another aspect, the display panel 110 may not be pre-divided into M×N regions A(1,1) to A(M,N), and a plurality of regions may be set by obtaining temperatures for a plurality of predetermined points of the display panel 110 by using the radiation thermometer 710 and grouping points having temperature deviations within a reference value into one group. In this aspect, since temperatures for the points included in each region may be different from each other within the reference value, a representative value (e.g., an average value) of the temperatures for the points included in each region may be set as an initial temperature of the corresponding region.

Referring again to FIG. 6, the first compensation unit 620 receives, from the first temperature sensor 150, the second reference temperature T2, which is a temperature of the display panel 110 obtained in the driving stage of the display device 100. The first compensation unit 620 also reads the temperature deviation information A(1,1)_TDI to A(M,N)_TDI for the respective regions stored in the temperature deviation storage unit 610. The first compensation unit 620 calculates current temperatures A(1,1)_CT to A(M,N)_CT for the respective regions of the display panel 110 in the driving stage of the display device 100 by using the second reference temperature T2 and the temperature deviation information A(1,1)_TDI to A(M,N)_TDI for the respective regions.

The first compensation unit 620 generates a second image data DATA2 by compensating luminance of a first image data DATA1 input from an external system or a graphic card by using the calculated current temperatures A(1,1)_CT to A(M,N)_CT for the respective regions.

In one aspect, the first compensation unit 620 reads, from the look-up table 630, compensation gain values mapped to the current temperatures A(1,1)_CT to A(M,N)_CT for the respective regions. The first compensation unit 620 generates the second image data DATA2 by compensating luminance of the first image data DATA1 to be output through the subpixels SP included in each region by reflecting the read compensation gain values in the first image data DATA1 for the respective regions.

As described above, according to the present disclosure, the first compensation unit 620 does not compensate a luminance of the display panel 110 by uniformly applying the second reference temperature T2 of the display panel 110 obtained by the first temperature sensor 150 to an entire area of the display panel 110, but compensates the first image data DATA1 to be output through the subpixels SP included in each region data to the second image data DATA2 by calculating the current temperatures for the respective regions of the display panel 110 and using compensation gain values determined according to the calculated current temperatures for the respective regions. Therefore, compensation accuracy can be improved, and image quality can be improved.

The look-up table 630 stores compensation gain values mapped to respective temperature ranges.

The second compensation unit 640 supplies the sensing reference voltage VSEN to the reference line RVL during a sensing period, generates compensation data based on sensing data SDATA transmitted from the data driving circuit 130, and generates a third image data DATA3 by reflecting the compensation data in the second image data DATA2 output from the first compensation unit 620.

In one aspect, the second compensation unit 640 calculates threshold voltage values of the respective subpixels SP corresponding to the sensing data SDATA, calculates a deviation between a compensation value corresponding to the calculated threshold voltage value and an initial compensation value (or previous compensation value) for a driving transistor Tdr of each subpixel SP, and generates the compensation data by adding or subtracting the calculated deviation to or from the initial compensation value (or previous compensation value).

The second compensation unit 640 outputs the third image data DATA3 to the data driving circuit 130.

In the above-described aspect, the timing controller 140 has been described as outputting the third image data DATA3 generated by the second compensation unit 640 to the data driving circuit 130. However, in another aspect, the timing controller 140 may output the second image data DATA2 generated by the first compensation unit 620 to the data driving circuit 130.

Hereinafter, referring to FIG. 8, a driving method of the display device according to the present disclosure will be described.

FIG. 8 is a flowchart illustrating a driving method of a display device according to an aspect of the present disclosure. The driving method of the display device illustrated in FIG. 8 may be applied to the display device 100 illustrated in FIG. 2.

First, as illustrated in FIG. 8, in the manufacturing stage of the display device 100, a first reference temperature T1 of the display panel 110 is obtained by using the first temperature sensor 150 in step S800. In one aspect, since the first temperature sensor 150 is mounted on the control printed circuit board CPCB together with the timing controller 140 as illustrated in FIG. 3, the first reference temperature T1 obtained by the first temperature sensor 150 may be defined as a temperature an area where the first temperature sensor 150 is mounted in the display panel 110.

Thereafter, in the manufacturing stage of the display device 100, initial temperatures for respective regions of the display panel 110 are obtained by using the second temperature sensor in step S810. The second temperature sensor is not mounted on the display device 100 unlike the first temperature sensor 150, and, for example, may be implemented as the radiation thermometer as illustrated in FIG. 7. In this case, the second temperature sensor is connected to the respective regions of the display panel 110 through wires to obtain the initial temperatures for the respective regions of the display panel 110.

In the above-described aspect, it has been described that the display panel 110 is pre-divided into a plurality of regions and the second temperature sensor is connected to each region of the display panel 110 to directly obtain the initial temperatures for the respective regions. However, in another aspect, the display panel 110 may not be pre-divided into a plurality of regions, and a plurality of regions may be set by obtaining temperatures for a plurality of predetermined points of the display panel 110 by using the second temperature sensor and grouping points having temperature deviations within a reference value into one group.

In this aspect, since temperatures for the points included in each region may be different from each other within the reference value, a representative value (e.g., an average value) of the temperatures for the points included in each region may be set as the initial temperature for the corresponding region.

In one aspect, obtaining the first reference temperature T1 in step S800 and obtaining the initial temperatures for respective regions in step S810 may be performed while a predetermined test image is output through the display panel 110 or predetermined data voltages are supplied to the respective subpixels SP through the data lines DL of the display panel 110.

Thereafter, in the manufacturing stage of the display device 100, in step S820, the temperature deviation information for the respective regions is calculated based on a difference between the first reference temperature T1 obtained in step S800 and the initial temperatures for the respective regions obtained in step S810.

The reason for calculating the temperature deviation information, which is a difference between the first reference temperature T1 and the initial temperatures for the respective regions, in the present disclosure is to calculate current temperatures for the respective regions of the display panel 110 by using the temperature deviation information for the respective regions and a second reference temperature T2 measured by the first temperature sensor 150 in the driving stage of the display device 100.

In a general display device, since a temperature obtained by one temperature sensor mounted on the display panel 110 is uniformly applied to entire regions of the display panel 110 to compensate for a luminance of the display panel 110, compensation accuracy is inevitably low. Therefore, in the present disclosure, by calculating the temperature deviation information corresponding to relative temperature information for the respective regions with respect to the first reference temperature T1 obtained by the first temperature sensor 150, even if only the second reference temperature T2 of the display panel 110 is obtained by the first temperature sensor 150 in the driving stage of the display device 100, current temperatures for all regions of the display panel 110 can be calculated without adding a separate temperature sensor.

Thereafter, in the driving stage of the display device 100, the second reference temperature T2, which is a current temperature of the display panel 110, by using the first temperature sensor 150 is obtained in step S830. In step S840, current temperatures for the respective regions are calculated by using the second reference temperature T2 obtained in step S830 and the temperature deviation information for the respective regions calculated in step S820. Specifically, the current temperatures for the respective regions may be calculated by summing the second reference temperature T2 and the temperature deviation information for the respective regions.

Thereafter, compensation gain values mapped to the current temperatures for the respective regions calculated in S840 are read from the look-up table for each region in step S850.

Thereafter, in step S860, the luminance of the first image data DATA1 is compensated by reflecting the compensation gain values for the respective regions read in S850 in the first image data DATA1 to be output through the subpixels included in each region to generate the second image data DATA2.

As described above, the display device 100 according to the present disclosure does not compensate the luminance of the display panel 110 by uniformly applying the second reference temperature T2 of the display panel measured by the first temperature sensor 150 to an entire area of the display panel 110, but compensates the first image data DATA1 to the second image data DATA2 for subpixels included in each region by calculating the current temperatures for the respective regions of the display panel 110 and using compensation gain values determined according to the calculated current temperatures for the respective regions. Therefore, compensation accuracy can be improved, and image quality can be improved.

Meanwhile, although not illustrated in FIG. 8, the display device 100 may acquire sensing data SDATA for each subpixel by supplying the sensing reference voltage VSEN to the reference line RVL during the sensing period, generate compensation data based on the sensing data SDATA, and generate third image data DATA3 by reflecting the compensation data in the second image date DATA2.

According to the present disclosure, in the manufacturing stage of the display panel, the temperature deviation information between the first reference temperature obtained by the first temperature sensor mounted on the display device and the initial temperatures for respective regions of the display panel obtained by the second temperature sensor not mounted on the display device may be stored. In the driving stage of the display device, the current temperatures for the respective regions when the display device is driven may be calculated by using the second reference temperature detected by the first temperature sensor and the temperature deviation information for the respective regions. Accordingly, since the current temperatures for the respective regions may be calculated using only one temperature sensor, the number of temperature sensors required to obtain the temperatures for the respective regions may be reduced, thereby reducing the manufacturing cost of the display device.

Additionally, according to the present disclosure, the current temperatures for respective regions in the driving stage of the display device may be calculated by using the temperature deviation information for the respective regions obtained during the manufacturing stage of the display device, and luminance for the respective regions may be compensated based on the current temperatures for the respective regions. Therefore, luminance deviations caused by temperature changes in the respective regions may be properly compensated, thereby preventing image defects such as display mura.

A person skilled in the art to which the present disclosure pertains will understand that the present disclosure described above may be implemented in other specific forms without changing its technical idea or characteristics.

Therefore, it should be understood that the aspects described above are exemplary in all respects and not limiting. The scope of the present disclosure is indicated by the claims described below rather than the detailed description, and all changes or modifications derived from the meaning and scope of the claims and their equivalent concepts should be interpreted as being included in the scope of the present disclosure.

What is claimed is:

1. A display panel control apparatus comprising:
a first temperature sensor configured to obtain a temperature of a display panel divided into a plurality of regions; and
a timing controller configured to calculate current temperatures for the respective regions by using pre-obtained temperature deviation information for respective regions of the display panel and a first reference temperature obtained by the first temperature sensor in a driving stage of the display panel, and compensate for luminance of the display panel by using the calculated current temperatures for the respective regions.

2. The display panel control apparatus of claim 1, wherein the timing controller comprises:
a temperature deviation storage unit storing the temperature deviation information for the respective regions;
a look-up table storing compensation gain values corresponding to temperatures; and
a first compensation unit configured to calculate the current temperatures for the respective regions by summing the first reference temperature and the temperature deviation information for the respective regions and compensate for the luminance of the display panel for the respective regions by using compensation gain values mapped to the current temperatures for the respective regions in the look-up table.

3. The display panel control apparatus of claim 2, wherein the first compensation unit is configured to generate second image data by compensating for luminance of first image data, through applying the compensation gain values selected for the respective regions to the first image data to be output through subpixels included in the respective regions.

4. The display panel control apparatus of claim 3, wherein the timing controller further comprises a second compensation unit configured to generate third image data by compensating for the second image data based on sensing data corresponding to characteristic values of the subpixels.

5. The display panel control apparatus of claim 1, wherein the temperature deviation information for the respective regions is a difference between initial temperatures for the respective regions of the display panel obtained by a second temperature sensor in a manufacturing stage of the display panel and a second reference temperature of the display panel obtained by the first temperature sensor in the manufacturing stage of the display panel.

6. The display panel control apparatus of claim 5, wherein the second temperature sensor is a radiation thermometer.

7. The display panel control apparatus of claim 1, wherein the respective regions of the display panel are set by grouping points, among a plurality of predetermined points of the display panel, having deviations between temperatures obtained by the second temperature sensor within a reference value, and
the temperature deviation information is a difference between an initial temperature for each region set based on a representative value of temperatures for the points included in each region and the second reference temperature of the display panel obtained by the first temperature sensor in a manufacturing stage of the display panel.

8. The display panel control apparatus of claim 1, further comprising a control printed circuit board on which the first temperature sensor and the timing controller are mounted.

9. A driving method for a display device including a display panel divided into a plurality of regions, the method comprising:
obtaining a first reference temperature of the display panel by using a first temperature sensor in a driving stage of the display panel;
calculating current temperatures for the respective regions of the display panel by using the first reference temperature and pre-obtained temperature deviation information for the respective regions of the display panel; and
compensating for a luminance of the display panel by using the calculated current temperatures for the respective regions.

10. The driving method of claim 9, wherein the compensating for the luminance of the display panel comprises:
extracting, from a look-up table storing compensation gain values corresponding to current temperatures for the respective regions, compensation gain values mapped to the current temperatures for the respective regions; and
generating second image data by applying the extracted compensation gain values to first image data to be output through subpixels included in the respective regions to compensate for luminance of the first image data.

11. The driving method of claim 10, further comprising generating third image data by compensating for the second image data based on sensing data corresponding to characteristic values of the plurality of subpixels included in the display panel.

12. The driving method of claim 9, further comprising calculating the temperature deviation information for the respective regions in a manufacturing stage of the display panel,
wherein the calculating the temperature deviation information for the respective regions comprises:
obtaining a second reference temperature of the display panel by using the first temperature sensor;
obtaining initial temperatures for the respective regions of the display panel by using a second temperature sensor; and
obtaining the temperature deviation information for the respective regions by using a difference between the initial temperatures for the respective regions and the second reference temperature.
